(19) United States
(12) Patent Application Publication
(10) Pub. No.: US 2011/0063100 A1
(43) Pub. Date: Mar. 17, 2011

(54) Truck Safety Device

(76) Inventors: John A. Jinksy, Wisconsin Rapids, WI (US); Russell L. Jinsky, Wisconsin Rapids, WI (US)

(21) Appl. No.: 12/880,579

(22) Filed: Sep. 13, 2010

Related U.S. Application Data
(60) Provisional application No. 61/242,022, filed on Sep. 14, 2009.

(51) Int. Cl. B60Q 1/50

(52) U.S. Cl. 340/467

(57) ABSTRACT

A braking indication system for illuminating the brake lamps on a vehicle having an engine braking device is disclosed. The vehicle may be slowed or stopped using either the brake pedal or the engine braking device. A first electrical conduction path is established between the vehicle power source and the brake lamps when the brake pedal is pressed. A second electrical conduction path is established between the vehicle power source and the brake lamps when the engine braking device is active. Thus, the brake lamps are illuminated when either the brake pedal or the engine braking device is used to slow the vehicle.

### CROSS-REFERENCE TO RELATED APPLICATIONS

This application claims priority to U.S. provisional application Ser. No. 61/242,022, filed Sep. 14, 2009, the entire contents of which is incorporated herein by reference.

### BACKGROUND OF THE INVENTION

The subject matter disclosed herein relates to a braking indicator system. More specifically, the subject matter discloses a braking indicator system configured to energize the brake lamps on a vehicle either during normal braking with a brake pedal or during the use of an engine braking device.

As is known to those skilled in the art, motor vehicles are equipped with brakes to slow and stop the vehicle and with a set of brake lights facing the rear of the vehicle to warn a motorist following behind that the vehicle in front is slowing or stopping. As vehicles increase in size and weight, the amount of braking force required to slow the vehicle similarly increases. Large trucks require a significant braking force and are commonly commercial vehicles travelling many more miles than the average vehicle. This combination of an increased braking force, required to stop the vehicle, and an increased frequency of braking due to the extra miles traveled can greatly increase the wear on brake equipment, resulting in an increased frequency and cost of maintenance.

Consequently, alternate means of slowing large trucks have been developed. A popular means of slowing these vehicles is by the use of an engine braking device. The engine braking device can be engaged to stop the flow of fuel to the engine and effectively convert the engine from a driving mechanism to an energy absorbing compressor. While engine braking may cause a distinctive noise, the engine braking device is not typically connected to the brake lamps. Due to the improved sound-proofing of vehicles or because a radio may be playing, a driver following a truck using an engine brake may not hear the noise produced by engine braking and have no indication that the truck is using the engine brake to slow down. Thus, it would be desirable to provide a low-cost, reliable system to illuminate the brake lamps when a truck engages an engine braking device.

### BRIEF DESCRIPTION OF THE INVENTION

The present invention provides a braking indicator system configured to light the brake lamps on a vehicle when the vehicle is slowed either by normal braking or by engine braking.

According to one embodiment of the invention, a vehicle has a first and a second braking system. The first braking system includes a first switch activated by a pedal and slows the vehicle by engaging a plurality of rotating members, each rotating member connected to a wheel of the vehicle. The second braking system is an engine brake. The vehicle includes a braking indicator system having a power source, at least one brake lamp selectively connected to the power source by the first switch when the pedal activates the first braking system, and a diode operably connected in series between the second braking system and the brake lamp such that the diode conducts power from the power source to the brake lamp when the second braking system is activated.

As another aspect of the invention, the braking indicator system may include a fusible link connected in series with the diode between the second braking system and the brake lamp. The vehicle typically includes a battery supplying twelve volts which may be used as the power source. Optionally, the vehicle may include a control voltage at a voltage level other than twelve volts, for example at five volts. The braking indicator system may further include a voltage converter operable to convert the control voltage to a twelve volt level suitable to energize the brake lamps.

Thus, it is a feature of this invention that the brake lamps for the vehicle provide a visual indication when either the traditional brakes, typically pads or shoes engaging discs or drums, respectively, within the wheels of the vehicle, or an engine brake is engaged to slow the vehicle.

According to another embodiment of the invention, the braking indicator system for a vehicle having a first and a second braking system includes a housing removably mounted to the vehicle having an input connection and an output connection. A power source is selectively connected to the input connection of the housing, and at least one brake lamp is selectively connected to the power source by activating either the first or second braking systems. A first switch is selectively energized by activating the first braking system which establishes a first electrical connection between the power source and the brake lamp. A diode located within the housing and operably connected in series between the input connection and the output connection of the housing establishes a second electrical connection in parallel with the first electrical connection between the power source and the brake lamp when the diode is forward biased via the voltage differential present between the input connection and the output connection of the housing when the second braking system is activated.

As still another aspect of this invention, the housing may be mounted within an engine compartment of the vehicle. The input connection includes a connector having a first member electrically connected to the diode within the housing and a second member electrically connected to the second braking system, and the first member and the second member are removably connectable. The output connection similarly includes at least one connector having a first member electrically connected to the diode within the housing and a second member electrically connected to one of the brake lamps, and the first member and the second member are removably connectable. The braking indicator system may further include a fusible link connected in series with the diode between the second braking system and the brake lamp.

According to still another embodiment of the present invention, a method of providing a visual indication that a vehicle, including a first and a second braking system, is slowing down is disclosed. A kit is provided for mounting to the vehicle. The kit includes a housing having an input connection, an output connection, and a diode operably connected between the input connection and the output connection. The input connection is connected to a terminal on the second braking system that is energized when the second braking system is active, and the output connection is connected to at least one brake lamp on the vehicle. At least one brake lamp is energized by activating the second braking system and forward biasing the diode to establish an electrical connection between the terminal and the brake lamp.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a schematic representation of a braking indicator system according to one embodiment of the present invention.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

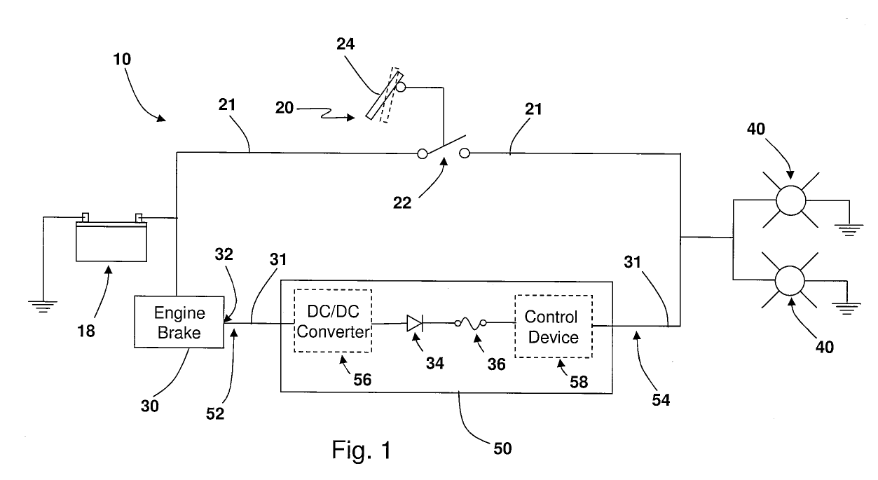

Turning to FIG. 1, a braking indicator system 10 according to one embodiment of the present invention is incorporated on a vehicle having a first braking system 20 and a second braking system 30. The first braking system 20 is preferably the vehicle's service braking system which engages the wheels of the vehicle. The service braking system utilizes brake pads or shoes, activated by hydraulic or pneumatic means as is known in the art, to engage a disc or drum, respectively, mounted on the wheel to slow the vehicle. The first braking system is typically activated by the driver pressing a brake pedal 24. Optionally, any other suitable braking system may be employed as the first braking system 20 by the vehicle. The second braking system 30 is preferably an engine brake. The engine brake operates on the exhaust system of a vehicle, and utilizes the vehicle's engine to help slow the vehicle. The engine braking system is typically enabled by a switch inside the vehicle and may be activated by releasing the clutch and gas pedals or by pressing the brake pedal 24. Any suitable engine braking system as is known in the art may be used as the second braking system 30.

The braking indicator system 10 is configured to permit the first or the second braking system, 20 or 30 respectively, to energize at least one brake lamp 40 on the vehicle, providing a visual indication to a driver following behind the vehicle that the vehicle is slowing down. The braking indicator system 10 includes a power source 18, a first switch 22 and at least one brake lamp 40. The power source 18 may be twelve volts and supplied by the vehicle's battery, as illustrated in FIG. 1. Optionally, the power source 18 may be a control voltage at any suitable level, for example five volts as generated by a voltage regulator on the vehicle. Further, a first voltage level may be supplied to the first braking system 10 and a second voltage level may be supplied to the second braking system 20.

The first switch 22 is preferably activated by a brake pedal 24 and connected in series between the power source 18 and the brake lamp 40. The first switch 22 closes to establish a first electrical connection 21 between the power source 18 and the brake lamp 40 when the brake pedal 24 is pressed, and the first switch 22 opens, breaking the first electrical connection 21, when the brake pedal 24 is released. In a separate circuit (not shown), pressing and releasing the brake pedal activates and deactivates the first braking system 20, respectively. Brake lamps 40 are mounted facing the rear of the vehicle to provide a visual indication to a driver following behind the vehicle. Brake lamps 40 may be, for example, a first set of lights mounted on the tractor of a truck and a second set of lights mounted on the trailer of a truck. Optionally, a single set of brake lamps 40 may be used on a truck which does not have a trailer, such as a dump truck. Thus, by energizing the brake lamp 40 when the brake pedal 24 is pressed, the braking indicator system 10 provides a visual indication that the vehicle is being slowed by the first braking system 20.

The braking indicator system 10 further provides a second electrical connection 31 between the power source 18 and the brake lamps 40 via the engine brake 30 and a diode 24 connected in series between the engine brake 30 and the brake lamps 40. The engine brake 30 receives power from the vehicle's power source 18 either directly at twelve volts, for example from a battery, or indirectly via a voltage converter (not shown) which converts the voltage level supplied from the battery to another control voltage level, such as five volts. Optionally, the engine brake 30 may receive power from the battery and include a voltage converter which outputs the voltage at a different level. The engine brake 30 also includes a terminal 32, or connection point, to which an electrical connection can be made. The terminal 32 may be any suitable connection point which is energized by the power source 18 when the engine brake 30 is active.

The diode 24 is preferably included within a housing 50 which may be mounted, for example, to the engine of the vehicle in proximity to the engine brake 30. The housing 50 includes an input connector 52 and an output connector 54. The input connector 52 is configured to establish an electrical connection with the terminal 32 of the engine brake 30, and the output connector 54 is configured to establish an electrical connection with the brake lamp 40. Both the input connector 52 and the output connector 54 preferably utilize a quick connector to facilitate maintenance on the braking indicator system 10. The input connector 52, for example, may include a first member of the quick connector to terminate an electrical conductor extending from the housing 50. A second member of the quick connector, complementary to the first member, is connected to another electrical conductor at one end and the other end of the electrical conductor is connected to the terminal 32 on the engine brake 30. Similarly, a quick connector is preferably connected to the electrical conductors between the output connector 54 and the brake lamps 40. Optionally, the input connector 52 may be directly connected to the terminal 32 of the engine brake 30 and the output connector 54 may be directly connected to the brake lamps 40. The diode is connected in series between the input connector 52 and the output connector 54 such that the diode is forward biased by a positive voltage differential existing from the input connector 52 to the output connector 54. Preferably, a fusible link 36 is also connected in series with the diode between the input connector 52 and the output connector 54. Optionally, any other suitable circuit protection means may be connected in series with the diode 34, such as an inline circuit breaker.

The braking indicator system 10 may optionally include a DC-to-DC converter 56. Because the voltage level at the input connector 52 may be different levels, for example twelve volts or five volts, the braking indicator system 10 may require a voltage converter 56 to convert the voltage from a first level at the input connector 52 to the voltage level desired for illuminating the brake lamps 40 at the output connector 54. Alternately, if the voltage level at the input connector 52 is the same as the voltage level desired at the output connector 54, no DC-to-DC converter 56 is required.

It is further contemplated that the first and second braking systems, 20 and 30, provide different visual indications such that a driver following the vehicle can distinguish which braking system is active. For example, the braking indicator system 10 may optionally include a control device 58 connected in series in the second electrical connection 31. The control device 58 may limit or interrupt the connection 31 between the power source 18 and the brake lamps 40 such that the lamps 40 may blink, fade on, fade off, or provide any other suitable indication that the second braking system 30 rather than the first braking system 20 is activating the lamps 40. It is further contemplated, that the second braking system 30 may be connected to a different lamp 40 than the first braking system 20. For example, the second braking system 30 may be connected to a vehicle's warning/hazard lights or flashers or any other lights mounted on the vehicle.

In operation, the braking indicator system 10 operates to illuminate the brake lamps 40 when either the first or the second braking system, 20 or 30 respectively, is activated. The first braking system 20 is typically the service brakes on the vehicle and is activated by pressing a brake pedal 24. Pressing the brake pedal 24 causes a first switch 22 to close, for example, by energizing the solenoid on a contactor. The closed switch is connected in series with, and establishes the first electrical connection 21 between, the power source 18 and the brake lamps 40. Thus, by pressing the brake pedal 24, the braking indicator system 10 provides a visual indication that the vehicle is being slowed by the first braking system 20.

The second braking system 30 is typically an engine brake 30. The engine brake 30 typically includes an enable switch located in the interior of the vehicle and within reach of the operator to enable/disable the engine brake 30. When the engine brake 30 is active, a voltage is present on the terminal 32 of the engine brake 30. Because the input connector 52 is connected to the terminal 32 and the output connector 54 is connected to the brake lamps 40, this voltage on the terminal 32 forward biases the diode 34 establishing electrical conduction through the diode 34. If the voltage level present on the terminal 32 is the same voltage level required by the brake lamps 40, then the input connector 52 may be directly connected to the diode 34. If a voltage level on the terminal 32 is other than the voltage level required by the brake lamps 40, a DC-to-DC converter 56 may be connected in series between the input connector 52 and the diode 34. The DC-to-DC converter then converts the voltage level present on the terminal 32 and the input connector 52 to the voltage level required by the brake lamps 40. Because a voltage is only present on the terminal 34 when the engine brake 30 is active and because the presence of a voltage on the terminal 34 establishes conduction through the diode 34, activating the engine brake 30 will activate the brake lamps 40 and provide a visual indication that the vehicle is being slowed by the second braking system 30.

When the engine brake 30 is not active, the diode 34 additionally prevents the first braking system 20 from energizing the second braking system 30. Because the first and the second braking systems, 20 and 30 respectively, each energize the brake lamps 40, when the first braking system is active, a voltage is present at the output connector 54 of the second braking system. However, under these operating conditions, the voltage potential from the output connector 54 to the input connector 52 reverse biases the diode, preventing electrical conduction via the second electrical connection 31.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention

We claim:

1. In a vehicle having a first and a second braking system, wherein the first braking system includes a first switch activated by a pedal and slows the vehicle by engaging a plurality of rotating members, each rotating member connected to a wheel of the vehicle, and wherein the second braking system is an engine brake, a braking indicator system comprising:
a power source;
at least one brake lamp selectively connected to the power source by the first switch when the pedal activates the first braking system; and
a diode operably connected in series between the second braking system and the brake lamp such that the diode conducts power from the power source to the brake lamp when the second braking system is activated.

2. The braking indicator system of claim 1 further comprising a fusible link connected in series with the diode between the second braking system and the brake lamp.

3. The braking indicator system of claim 2 wherein the vehicle includes a battery supplying twelve volts and the power source is the battery.

4. The braking indicator system of claim 2 wherein the vehicle includes a control voltage at five volts and the braking indicator system further comprises a voltage converter operable to convert the control voltage to a second voltage level at twelve volts.

5. The braking indicator system of claim 2 further comprising a control device connected in series with the diode between the second braking system and the brake lamp, wherein the control device, at least in part, limits the voltage applied to the brake lamp such that the visual indication provided by the brake lamp is different for the first braking system than for the second braking system.

6. A braking indicator system for a vehicle having a first and a second braking system, comprising:
a housing removably mounted to the vehicle and having an input connection and an output connection;
a power source selectively connected to the input connection of the housing;
at least one lamp selectively connected to the power source by activating one of the first and the second braking systems;
a first switch selectively energized by activating the first braking system to establish a first electrical connection between the power source and the lamp; and
a diode located within the housing and operably connected in series between the input connection and the output connection of the housing wherein the diode is forward biased and establishes a second electrical connection, in parallel with the first electrical connection, between the power source and the lamp via the input connection and the output connection of the housing when the second braking system is activated.

7. The braking indicator system of claim 6 wherein the lamp is one of a brake lamp and a hazard lamp of the vehicle.

8. The braking indicator system of claim 6 wherein the input connection includes a connector having a first member electrically connected to the diode within the housing and a second member electrically connected to the second braking system wherein the first member and the second member are removably connectable.

9. The braking indicator system of claim 8 wherein the output connection includes at least one connector having a first member electrically connected to the diode within the housing and a second member electrically connected to one of the lamps wherein the first member and the second member are removably connectable.

10. The braking indicator system of claim 6 wherein the first braking system engages a rotating member connected to the wheel and the second braking system is an engine brake.

11. The braking indicator system of claim 10 further comprising a fusible link connected in series with the diode between the second braking system and the lamp.

12. The braking indicator system of claim 11 wherein the vehicle includes a battery supplying twelve volts and the power source is the battery.

13. The braking indicator system of claim 11 wherein the vehicle includes a control voltage at five volts and the braking indicator system further comprises a voltage converter operable to convert the control voltage to a second voltage level at twelve volts.

14. The braking indicator system of claim 6 wherein the housing is mounted within an engine compartment of the vehicle.

15. A method of providing a visual indication that a vehicle is slowing down wherein the vehicle includes a first and a second braking system, the steps comprising:
providing a kit for mounting to the vehicle, the kit including a housing having an input connection, an output connection, and a diode operably connected between the input connection and the output connection;
connecting the input connection to a terminal on the second braking system that is energized when the second braking system is active;
connecting the output connection to at least one brake lamp on the vehicle; and
energizing the at least one brake lamp by activating the second braking system and forward biasing the diode to establish an electrical connection between the terminal and the brake lamp.
